(19) United States
(12) Patent Application Publication
(10) Pub. No.: US 2018/0263306 A1
(43) Pub. Date: Sep. 20, 2018

(54) Hanoch dental bib

(71) Applicant: HANOCH THOMPSON, Moncks Corner, SC (US)

(72) Inventor: HANOCH THOMPSON, Moncks Corner, SC (US)

(73) Assignee: HANOCH THOMPSON, Moncks Corner, SC (US)

(21) Appl. No.: 15/462,891

(22) Filed: Mar. 19, 2017

(51) Int. Cl. A41D 13/04; A41D 27/08; B41M 3/00

(52) U.S. Cl. CPC A41D 13/04; B41M 3/00; A41D 27/08

(57) ABSTRACT

A hanoch dental bib, to be worn by a patient during dental procedures, that incorporates the dentition of the human mouth integral to the bib. The hanoch dental bib can be utilize to protect the patient's clothing from liquid and/or solid debris produce during a dental procedure, and to wipe the patient's face and mouth at the completion of a dental procedure. The hanoch dental bib will be use to display the dentition of the mouth such that the dentist or healthcare professional can identify the correct tooth/teeth to proceed with dental care. The bib is secured to the wearer by mechanical means and worn over the chest as a bib. The hanoch dental bib as a absorption side and waterproof/impermeable side.

### FIELD OF THE INVENTION

The current invention outlines normally relates to the field of dental equipment and supplies, Specifically dental bibs. More importantly the current invention provide an addition purpose for a dental bib [hereinafter “hanoch dental bib”] by displaying the dentition of the human mouth for correct teeth identifier.

### BACKGROUND

Unless specifically indicated otherwise, the materials described in this section are not prior art to the claims in this application, and are not admitted to be prior art by inclusion in this section.

Wrong-site surgery is rare to the general public, but are serious events that can have substantial consequences for patients and healthcare providers. It happens when a surgical or invasive procedure is undertaken on the wrong body part, wrong patient, or the wrong procedure is performed all together. The adverse events are sometime devastating and often result in litigation, fine and intervention, but their frequency and root causes continue to be unknown. Wrong-side/wrong-site, wrong-procedure, and wrong-patient events are likely to continue to be a ongoing problem as dentists and doctors demand continue to grow. Even with all the modern comfort to prevent such event, they continue to happen.

Before our invention, dental offices took great efforts to be proactive and resilient to limit the incidents of wrong site procedure by having time out, daily huddle to verify right side, right patient, right procedure. The result has been mix and with continue wrong site still happening, the need for additional safeguard is needed.

Dental bib are made out of many different material but serve two general function, one absorbent layer that is soft to the touch that is fused to an impermeable/waterproof layer that don't allow for any kind of absorption, it is shiny in appearance and glossy to the touch. This layer also serves as an additional protective for patient clothes. Most dental bib are use one time and discorded.

What is needed is new dental protective bib that is used as an additional safeguard in patient identifier

### SUMMARY OF THE INVENTION

In light of the what I just mention, limitation and constant miscues even with the added safeguards, the current invention help and add an addition verification just before any anesthesia or instrument is used on a patient.

The principal purpose for this invention is to supply a dental bib that is able to reduce to zero wrong site, wrong teeth during a dental procedure.

### BRIEF DRAWINGS DESCRIPTION

The basic description of the invention, as well as its object, aspects and advantages will be easily explainable upon reference to the detailed description and reference to accompany drawings.

FIG. 1 is one alternative perspective frontal view of hanoch's dental bib.

FIG. 2 is a perspective rear view of hanoch's dental bib.

FIG. 3 is one alternative perspective frontal view of hanoch's dental bib in use.

FIG. 4 is one alternative perspective frontal view of hanoch's dental bib with markings.

FIG. 5 is one alternative perspective frontal view of hanoch's dental bib.

FIG. 6 is a perspective rear view of hanoch's dental bib.

FIG. 7 is one alternative perspective frontal view of hanoch's dental bib in use.

FIG. 8 is one alternative perspective frontal view of hanoch's dental bib with markings.

FIG. 9 is one alternative perspective frontal view of hanoch's dental bib.

FIG. 10 is a perspective rear view of hanoch's dental bib.

FIG. 11 is one alternative perspective frontal view of hanoch's dental bib in use.

FIG. 12 is one alternative perspective frontal view of hanoch's dental bib with markings.

### DETAILED DESCRIPTION OF THE INVENTION

The following description is made available so that any relevant individual skill in the art of dentistry or any such similar discipline can use such invention. The present invention shall not be restricted in any form by the example given, rather by the extent of the invention claims will allow.

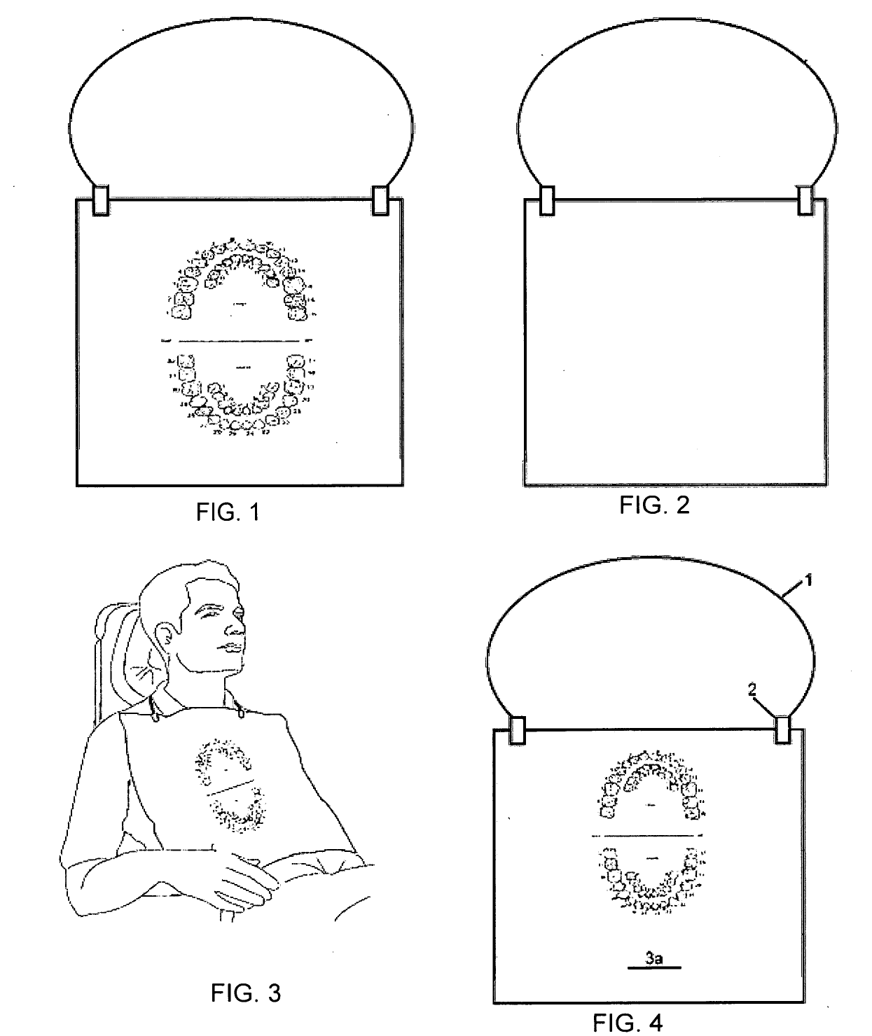

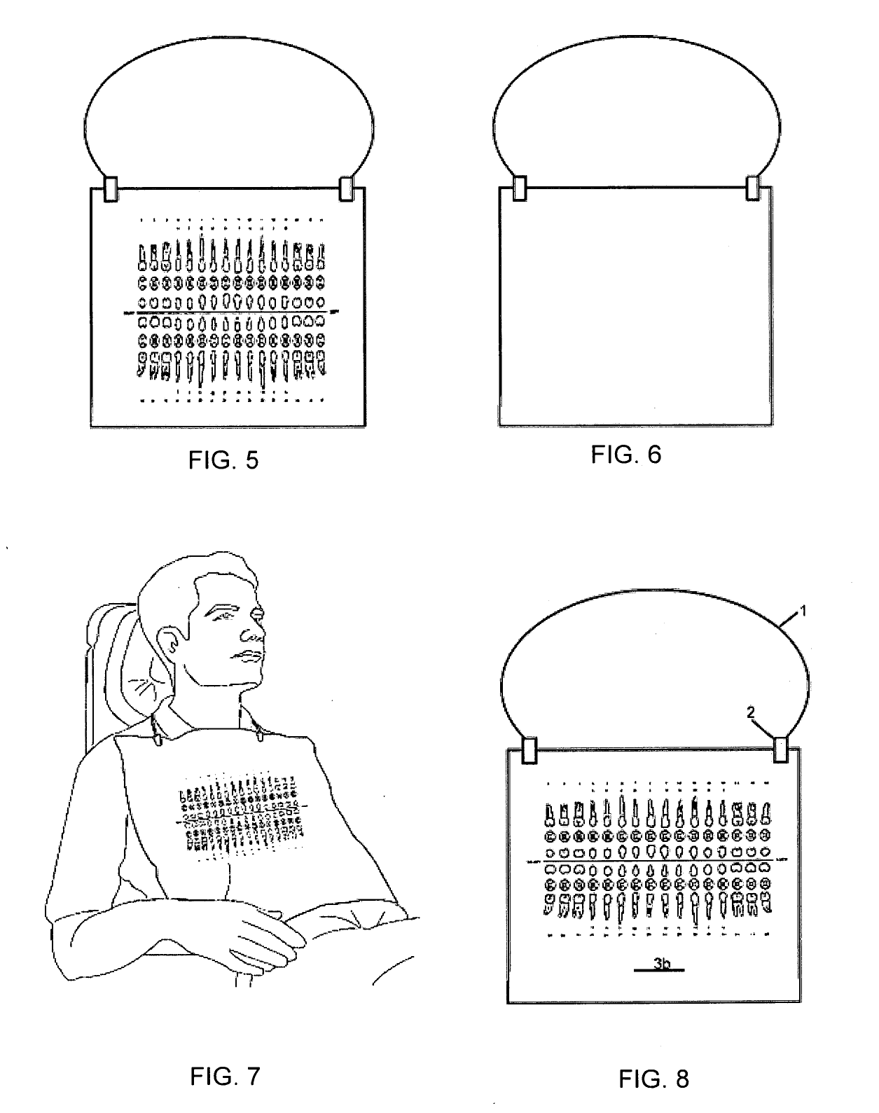

Referring now to the drawings, FIG. 1, FIG. 5, FIG. 9 are different alternative perspective frontal view of hanoch's dental bib with dental dentition being the integrate part of the bib. The hanoch's bib has a absorbent layer which as the dental dentition on front view and an impermeable layer that attach to the rear of the absorbent layer. Bib is attach to patient by a bib clip holder and bib clips that is fashion into the bib or an mechanical bib clips with holder that is attached to bib. Construction of dental bib can be fashion from any material feasible for that situation.

FIG. 2, FIG. 6, FIG. 10 represent the rare view of hanoch's dental bib, showing the impermeable layer, along with dental bib holder and dental bibs.

FIG. 3, FIG. 7, FIG. 11, represent different alternative perspective frontal view of hanoch's dental bib with dental dentition being the integrate part of the bib worn by a patient.

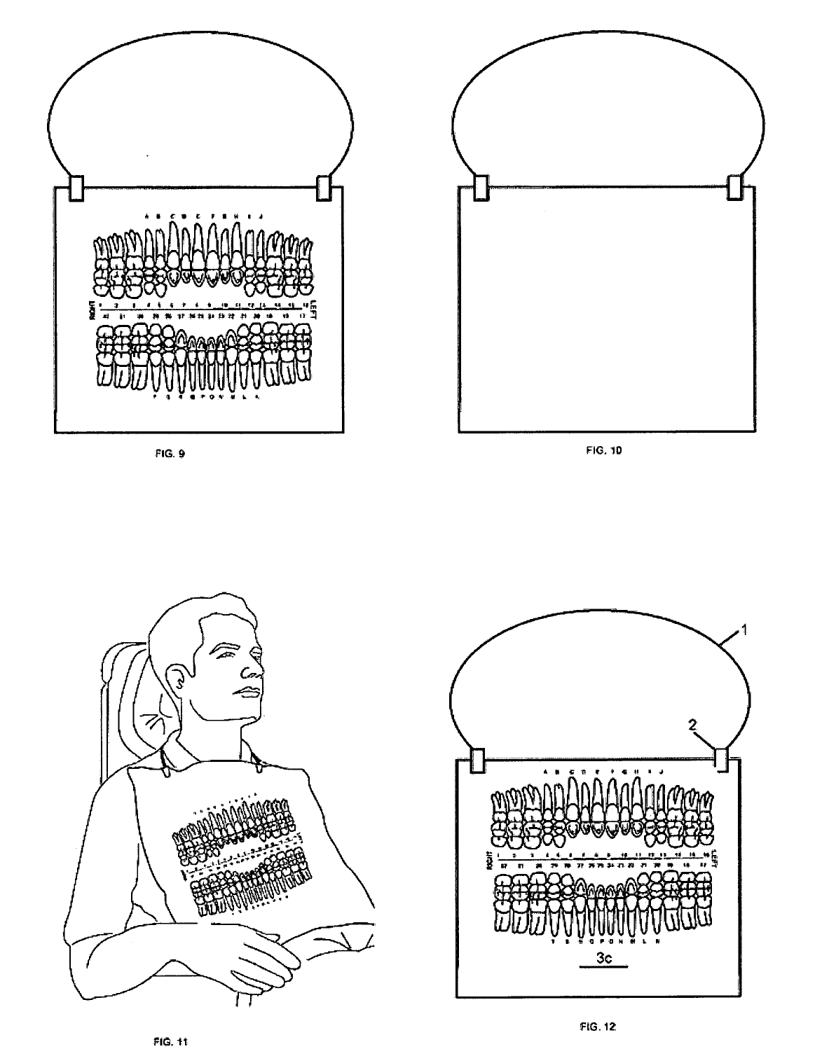

FIG. 4, FIG. 8, FIG. 12, represent different alternative perspective frontal view of hanoch's dental bib with dental dentition being the integrate part of the bib; the bib holder 1, bib clip 2 and dental bib 3a, 3b, and 3c respectively.

1. The is a protective bib or drape with an absorbent side and a substantially waterproof side, that is used in patient healthcare, that display the dentition of a human mouth by position, location, letter and/or number with or without bib clip placement markers or holes to prevent wrong site placement. Dentition image is apply or secure to protective bib by the use of digital printing method or inkjet method.
The main body of bib or drape is secured to a wearer by a bib clip holder that is built in the main body of the bib or a mechanical clip attach to a holder and bib.

2. the protective bib or drape according to claim 1, where upon the dentition image of teeth is apply or secure to bib by use of an adhesive material or impact printing method.

3. the protective bib or drape according to claim 1, where upon the dentition image of teeth is apply or secure to bib by use of a Fabric method,

4. the protective bib or drape according to claim 1, where upon the dentition image of teeth is apply or secure to bib by use of Professional Printing with Spoonflow

5. the protective bib or drape according to claim 1, where upon the dentition image of teeth is apply or secure to bib by use of a Projector Method or Screen display method.

6. the protective bib or drape according to claim 1, where upon the dentition image of teeth is apply or secure to bib by use of Gesso on Canvas technique.

7. the protective bib or drape according to claim 1, where upon the dentition image of teeth is apply or secure to bib by use of a laser printing/electrostatic method.

8. the protective bib or drape according to claim 1, where upon the dentition image of teeth is apply or secure to bib by use of a offset lithography method.

9. the protective bib or drape according to claim 1, where upon the dentition image of teeth is apply or secure to bib by use of a flexography method.

10. the protective bib or drape according to claim 1, where upon the dentition image of teeth is apply or secure to bib by use of a Gravure method or Rotogravure Method

11. the protective bib or drape according to claim 1, where upon the dentition image of teeth is apply or secure to bib by use of a screen printing,

12. the protective bib or drape according to claim 1, where upon the dentition image of teeth is apply or secure to bib by use of a Letterpress printing.

13. the protective bib or drape according to claim 1, where upon the dentition image of teeth is apply or secure to bib by use of a contact printing method

14. the protective bib or drape according to claim 1, where upon the dentition image of teeth is apply or secure to bib by use of Solid ink method or solid laser method.

15. the protective bib or drape according to claim 1, where upon the dentition image of teeth is apply or secure to bib by use of 3D printing method.

16. the protective bib or drape according to claim 1, where upon the dentition image of teeth is apply or secure to bib by use of a Printed electronics Method

17. the protective bib or drape according to claim 1, where upon the dentition image of teeth is apply or secure to bib by use of a transfer method,

18. the protective bib or drape according to claim 1, where upon the dentition image of teeth is apply or secure to bib by use of a dot matrix printing or impact matrix printing.

19. the protective bib or drape according to claim 1, where upon the dentition image of teeth is apply or secure to bib by use of a line printing method.

20. the protective bib or drape according to claim 1, where upon the dentition image of teeth is apply or secure to bib by use of acid-base method.
